(19) United States
(12) Patent Application Publication
(10) Pub. No.: US 2012/0118255 A1
(43) Pub. Date: May 17, 2012

(54) WATER-DILUTABLE ANTIFRICTION LACQUER FOR COATING ENGINE PISTONS

(76) Inventors: Christian Jung, Oberhaid (DE); Jurgen Reitenspies, Altdorf (DE)

(21) Appl. No.: 13/318,231

(22) PCT Filed: Apr. 27, 2010
(86) PCT No.: PCT/EP2010/055618

§ 371 Date: Feb. 1, 2012

(30) Foreign Application Priority Data
Apr. 29, 2009 (DE) 102009002715.7

(51) Int. Cl. F02F 3/10; F16J 1/00; C10M 103/02

(52) U.S. Cl. 123/193.6; 508/131; 508/129; 92/172

(57) ABSTRACT

A piston coating is described that comprises at least one aqueous dispersion selected from among the group including phenolic resins, epoxy resins, polyvinyl butyral, or the condensation products thereof, and at elast one solid lubricant selected from among the group including graphite, MoS₂, WS₂, and BN. Said coating dispenses with the use of toxic solvents and has a wear resistance and a coefficient of friction similar to those of conventional coatings.

International Application Number: PCT/EP2010/055618 Date of Application: 27 Apr. 2010 Title: Water-dilutable antifriction lacquer for coating engine pistons

### TECHNICAL FIELD

The invention relates to a coating for pistons, in particular a coating for the piston shaft of an internal combustion engine.

### PRIOR ART

Coatings for the piston shaft should exhibit a high wear resistance and at the same time a low coefficient of friction. In particular a high durability and wear resistance is required in engine operating regimes subject to a high degree of wear, such as repeated cold starts. In this connection, depletion of the coating in the load-bearing regions of the piston shaft should above all be avoided.

Various coatings for pistons of internal combustion engines are known in the prior art.

For example, U.S. Pat. No. 5,486,299 describes a lubricant composition for coating the surface of pistons and/or cylinders of engines that use alcohol or non-petroleum based products as fuel. This lubricant composition comprises a mixture of graphite, MoS₂, and PTFE in a matrix of a polyamide imide resin (PAI resin).

EP 1 469 050 A1 describes a coating composition for pistons, which is obtained by mixing uncured polyamide imide (PAI) with a solid lubricant such as PTFE, titanium oxide powder and a silane coupling agent.

DE 10 2005 026 664 A1 also describes a coating for a piston based on a PAI lacquer. This coating is PTFE-free and contains 5-15 wt. % zinc sulphide, 5-15 wt. % graphite or MoS₂, and 5-15 wt. % TiO₂. Both zinc sulphide and TiO₂ are used in the form of fine particles with a particle size of ≦0.7 μm.

De 43 43 439 A1 describes a reciprocating piston arrangement, which comprises a piston with a piston skirt formed in the manner of a relief with webs, which are coated with a solid lubricant of graphite, MoS₂ and BN in an epoxy resin.

EP 0 976 795 A2 describes a corrosion protection lubricant for hinges and the like, which contains as lubricant a mixture of phenolic resin, epoxy resin, polyvinyl butyral resin and polyolefin wax. The coating also contains aluminium particles, zinc particles or a metal phosphate as corrosion inhibitor, and a solvent.

DE 103 29 228 A 1 describes a polymer composite material for slide bearings with a polymer matrix that can, for example, consist of epoxy resin or PEEK. A filler material and nanoscale particles are embedded in this polymer matrix. Aramide fibres, glass fibres, carbon fibres, glass spheres, PTFE, graphite and silicones can be used as filler material. The nanoscale particles can be formed by TiO₂, Al₂O₃, MgO, ZeO₂, SiC, Si₃N₄, BN, glasses and hard solid metallic materials.

On account of the binder composition, the piston coatings of the prior art contain solvents. Particularly in the case of PAI-based coatings, toxicologically harmful solvents such as N-methylpyrrolidone, N-ethylpyrrolidone or γ-butyrlactone are required for this purpose. Commercially available products based on phenolic resins may contain considerable amounts of free phenol.

### OUTLINE OF THE INVENTION

The object of the invention is to provide a coating composition for a piston, in which the use of toxic solvents or monomers such as phenol can be reduced or even avoided.

This object is achieved by the coating composition according to claim 1.

The coating composition according to the invention comprises at least one aqueous dispersion selected from the group consisting of phenolic resins, epoxy resins, polyvinyl butyral or the condensation products thereof.

Surprisingly, it has been found that formulations based on such aqueous dispersions provide highly adherent, low-friction and wear-resistant piston coatings, in particular piston shaft coatings, the properties of which are as good as or even superior to the solvent-containing systems of the prior art.

Water-dilutable phenolic resin dispersions in water or butyl glycol can be used according to the invention as phenolic resins.

Water-dilutable epoxy resins of the bisphenol A type with epoxy equivalents >700 g/mol can be used according to the invention as epoxy resins. Those epoxy resins that can be cross-linked with resols via hydroxyl groups are particularly suitable. Water-dilutable, thermally curable phenol-epoxy resin precondensates are particularly preferably used.

Polyvinyl butyral can likewise be used in the form of water-dilutable dispersions.

Preferably, the resins used are present in an amount of 20-40 wt. % (solids content) based on the total composition.

The used polymer dispersions can within the scope of the invention be present diluted in pure water or water-solvent mixtures. Suitable co-solvents are, for example, butyl glycol, propylene glycol, dipropylene glycol n-butyl ether or also white spirit. In this connection, the water/solvent ratio is preferably 1:2 or more, particularly preferably 1:1 or more.

Graphite, MoS₂, WS₂ and/or BN are added as solid lubricants to the composition. In this connection grades generally known to the person skilled in the art can be used as solid lubricant. Graphite with a mean grain size of 1-100 μm, particularly preferably 5-50 μm, is preferably used. Molybdenum disulphide is preferably used with a mean grain size of 0.1-50 μm, particularly preferably 0.1-10 μm. Boron nitride in the hexagonal modification is preferably used with a mean grain size in the range from 1 to 100 μm, particularly preferably in the range from 1 to 20 μm.

The grain size of the aforementioned solid lubricants can be determined by means of light scattering measurements in a manner known to the person skilled in the art.

In a particularly preferred embodiment, the composition is PTFE-free.

The solid lubricants are preferably used in an amount of 10-40 wt. % based on the total composition. The composition can contain carbon fibres as a further component. Preferably, these are used in an amount of 2-10 wt. % based on the total composition. Carbon fibres are preferred with a mean fibre thickness of ≦100 μm, preferably 1-10 μm, and also with a mean fibre length of ≦1000 μm, preferably 10-500 μm. The composition according to the invention can also contain so-called carbon nanofibres, the mean fibre thickness of which, in contrast to conventional carbon fibres, is less than 1 μm, preferably in a range from 10 to 500 μm. In this connection, the thickness and the length of conventional carbon fibres are measured with a light microscope. With carbon nanofibres, the thickness and the length are determined by means of scanning electron microscopy.

In addition to the components mentioned above, the composition can also contain additives and auxiliary substances, such as flow-control additives, anti-foaming agents, wetting agents, dispersing aids or rheological additives.

Particularly preferred embodiments of the coating compositions according to the invention are shown in the following Table (amounts given in g/100 g of the total formulation; amount of the resins referred to the solids content):

| g/100 g | 1 | 2 | 3 | 4 | 5 | 6 |
|---|---|---|---|---|---|---|
| Phenolic resin/ | 25-35 | 30-40 | 25-35 | 25-35 | 30-40 | 25-35 |
| epoxy resin (1:2) | | | | | | |
| Graphite | 20-25 | 15-20 | 10-15 | 15-20 | 10-15 | 10-15 |
| MoS₂ | | | 10-15 | | | |
| Carbon fibres | | | | 2-5 | 5-10 | |
| TiO₂ | | | | | | 5-10 |
| Water/butyl | 40-55 | 40-55 | 35-55 | 40-58 | 35-55 | 40-60 |
| glycol (1:1)/ | | | | | | |
| auxiliary | | | | | | |
| substances | | | | | | |

The invention is described in more detail hereinafter with the aid of examples, which should not be regarded as restricting the subject matter of the invention.

### EXAMPLES

All amounts are given in wt. % referred to the total formulation. The amount of the resins refers to the solids content. The amount of the additives and auxiliary substances refers to the as-supplied form.

| | 1 | 2 | 3 | 4 | 5 | 6 |
|---|---|---|---|---|---|---|
| Phenolic resin/ | 30 | 35 | 30 | 30 | 35 | 30 |
| epoxy resin (1:2) | | | | | | |
| Graphite | 23 | 18 | 12 | 18 | 12 | 12 |
| MoS₂ | | | 12 | | | |
| Carbon fibres | | | | 4 | 8 | |
| TiO₂ | | | | | | 6 |
| Water/butyl | 47 | 47 | 46 | 48 | 45 | 52 |
| glycol (1:1)/ | | | | | | |
| auxiliary substances | | | | | | |

Phenolic resin: Water-dilutable, thermally curable phenolic resin dispersion
Epoxy resin: Water-dilutable epoxy resin dispersion with an epoxy equivalent of 1600-2000 g/mol
Carbon fibres: Mean fibre thickness <100 μm; fibre length <1000 μm
TiO₂: Dispersion of titanium dioxide (rutile); fineness <5 μm

Comparison Examples

| | V1 | V2 |
|---|---|---|
| Phenolic resin | 12 | |
| Epoxy resin | 19 | |
| Polyamtde imide | | 30 |
| Graphite | 18 | 18 |
| N-methylpyrrolidone/ | 51 | 52 |
| auxiliary substances | | |

Phenolic resin: Thermally curable resol; molecular weight 500-1500 g/mol
Epoxy resin: Bisphenol A type; molecular weight 2000-4000 g/mol
Polyamide imide: Resistherm A1 244L (Bayer Material Science)

Evaluation

The tribological properties of the layers were investigated with a Cameron Flint TE-77 Tribotester (frictional wear test). For this purpose, aluminium samples were coated with the lacquer formulations according to the invention and the coefficient of friction of the layers paired with cast iron as counter-piece was measured. The measurements were carried out under a load of 150 N and at a vibration frequency of 25 Hz in the unoiled state. The wear resistance of the layers was visually assessed on the basis of the test bodies and awarded a score of 1 to 3.

It was found in particular that the water-dilutable coatings according to the invention are just as good as or even superior to in terms of friction and wear the solvent-containing formulation of the comparison examples.

| | 1 | 2 | 3 | 4 | 5 | 6 | V1 | V2 |
|---|---|---|---|---|---|---|---|---|
| Coefficient | 0.18 | 0.18 | 0.16 | 0.14 | 0.12 | 0.22 | 0.17 | 0.22 |
| of friction | | | | | | | | |
| Wear | 2 | 2 | 2 | 1 | 1 | 2 | 2 | 2 |
| resistance* | | | | | | | | |

*Evaluation 1: high; 2: moderate; 3: low

1. A coating composition comprising at least one aqueous dispersion selected from the group consisting of phenolic resins, epoxy resins, polyvinyl butyral or the condensation products thereof and at least one solid lubricant selected from the group consisting of graphite, MoS₂, WS₂ and BN.

2. A coating composition according to claim 1, which is free of PTFE.

3. A coating composition according to one of claims 1, which contains further additives and auxiliary substances.

4. A coating composition according to claim 1, wherein the resin(s) that is/are used is/are present in an amount of 20-40 wt. % solids content based on the total composition.

5. A coating composition according to claims 1, wherein the solid lubricant(s) is/are used in an amount of 10-40 wt. % based on the total composition.

6. A coating composition according to claim 1, which additionally contains carbon fibres.

7. A piston having a coating composition according to claim 1.

8. The piston of claim 7, wherein the coating composition is applied to the piston shaft.

9. The piston of claim 7, wherein the piston is an internal combustion engine piston.
